(19) United States
(12) Patent Application Publication
(10) Pub. No.: US 2012/0019022 A1
(43) Pub. Date: Jan. 26, 2012

(54) VEHICLE FLOOR MATS WITH REPLACEABLE ASPECTS

(76) Inventor: Alice CIANCI, Lewisburg, WV (US)

(21) Appl. No.: 13/186,071

(22) Filed: Jul. 19, 2011

Related U.S. Application Data
(60) Provisional application No. 61/366,684, filed on Jul. 22, 2010.

(51) Int. Cl. B62D 25/20

(52) U.S. Cl. 296/97.23

(57) ABSTRACT

A durable floor mat may include a plurality of layers of replaceable covers such as paper or fabric having special coatings for the protection of the interior of the automobile. The floor mat may include loops and hooks or clasps to hold the replaceable paper in place and to aid in the ease of removal of each layer of replaceable paper.

### CROSS REFERENCE TO RELATED APPLICATIONS

This application claims benefit of U.S. Provisional Application No. 61/366,684, filed Jul. 22, 2010, entitled VEHICLE FLOOR MATS WITH REPLACEABLE ASPECTS, the disclosure of which is incorporated by reference herein.

### BACKGROUND

2.0 Field of the Invention

This invention relates generally to an apparatus and method for a floor mat for vehicles with replaceable covers such as paper or polymer, for example, and, more particularly, relates generally to an apparatus and method for mating the mat to the replaceable covers so that they may be easily detachable from the floor mat.

3.0 Related Art

When using an automobile, it is often difficult for the consumer to keep floor mats and vehicle interiors clean and nice looking due to outside factors such as inclement weather and soiled footwear, or the like. This is especially true during periods of rain or snow, when off-road driving, or even when taking the automobile for service where grime may be a primary concern. The possibilities for staining or even ruining the interior of your car, and more specifically traditional floor mats and carpeting beneath, are numerous and a common consumer issue. Rain water beneath or on the floorboard carpeting, for example, can cause damage to the vehicle and consumer health such as that resulting from corrosion and mold. In addition, once stained, cleaning or replacing the interior of the automobile due to corrosion and/or carpet due to the mold, may be costly.

### SUMMARY OF THE INVENTION

The above issues and problems are resolved by the apparatus and method provided by the invention so that the interior of a consumer's automobile, or the like, is maintained in a clean and like-new condition.

In one aspect, a heavy duty rubber mat is provided for the floorboard of an automobile intended to contain a replaceable top portion that is designed to assist in keeping outside elements from coming into contact with the interior of the automobile by containing such elements to a fully removable specially-treated paper or fabric.

In another aspect, the heavy duty mat and replaceable covers is designed for convenience so that the apparatus need not be physically removed from the automobile to remove the replaceable cover to obtain subsequent layers.

In one aspect, a vehicle floor mat is provided that includes a base configured to hold a set of individually removable covers and the set of individually removable covers.

In another aspect, a method for constructing a vehicle floor mat is provided that includes providing a base configured to hold a set of individually removable covers and providing the set of individually removable covers.

In one aspect, a vehicle floor mat is provided including means for providing vehicle floor protection in multiple layers, means for holding the means for providing vehicle floor protection in multiple layers in place for a specific vehicle floor design, and wherein the multiple layers are individually removable to expose another layer.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIG. 1 is a partial cross-sectional perspective view of an aspect of a floor mat, configured according to principles of the invention;

FIG. 2 illustrates the floor mat, showing the mat base and hook and loop pieces, configured according to principles of the invention;

FIG. 3 is .a perspective view of an exemplary aspect of a floor mat, configured according to principles of the invention;

FIG. 4 is a fully assembled perspective view of an aspect of the floor mat, configured according to principles of the invention;

FIG. 5 is an illustration showing a set of push-up tabs, attached to the base of the floor mat to be used to hold replaceable floor mat covers in place, configured according to principles of the invention;

FIG. 6a is a close up and overhead view of a push-up tab of FIG. 5, configured according to principles of the invention;

FIG. 6b is a close-up view of a push-up tab of FIG. 5, configured according to principles of the invention;

FIG. 7a is an illustration of tabs, configured according to principles of the invention;

FIG. 7b is a close-up view of a swivel tab of FIG. 7a, in a locked position, configured according to principles of the invention; and

FIG. 7c is an additional view of a swivel tab of FIG. 7a, in an unlocked position, configured according to principles of the invention;

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by any claims and applicable law. Moreover, it is noted that like reference numerals represent similar parts throughout the several views of the drawings.

It is understood that the invention is not limited to the particular methodology, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

The apparatus and method of the invention may include providing consumers an ability to protect the interior of their vehicle, whether personal, commercial, agricultural, or the like, by aiding to keep it clean and sanitary. In this way, the consumer's vehicle interior may avoid costly cleaning or replacement of interior, for example. Other aspects of the invention may include ease of installation and a mechanism configured to secure the replaceable covers such that the user is not required to remove the entire floor mat from the vehicle when replacing the covers, as well as safety features including a non-slip surface on the bottom of the floor mat, for example.

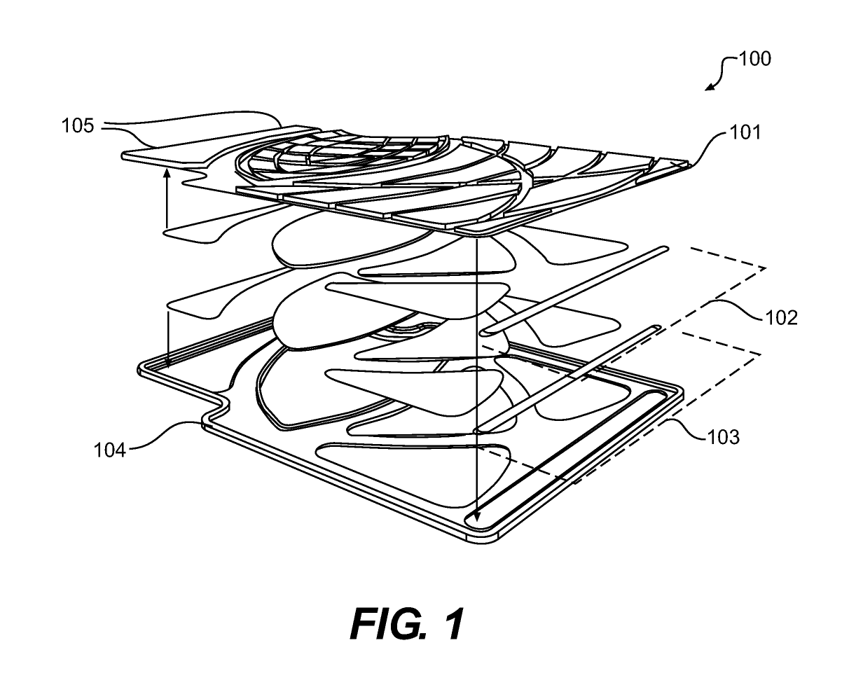

FIG. 1 is a partial cross-sectional perspective view of an exemplary floor mat, configured according to principles of the invention, generally denoted by reference number 100. The floor mat 100 may comprise a mat base 104 constructed of a material such as a rubber composite, and in this example, generally represents an exemplary front passenger floor mat for a mid-size car measuring approximately 17.5″×25″; however, other versions of the invention may be applied to the backseat floor mats as well and may be scaled accordingly for any size vehicle from compact, economy cars to full-sized, commercial trucks, for example. Furthermore, the floor mats may be utilized in other vehicles such as large farm equipment, airplanes, trains, buses and the like. Moreover, versions may be utilized as floor mats in buildings and offices, for example. Any example of the floor mats constructed according to principles of the invention may include alternative materials such as nylon or carpet, for example.

Replaceable floor mat cover(s) 101 may be made from heavy duty paper or polymer, or the like, may include one or more individual covers (e.g., layered on top of one another) that may be replaced according to principles of the invention. These replaceable floor mat cover(s) 101 may be secured to the top of the mat base 104 by looped pieces 102 at the bottom of the replaceable floor mat cover(s) and further secured to the top of the floor mat base 104 by hooked pieces 103 (e.g., Velcro®, a trademark of Velcro Industries, B.V.), thereby allowing the user to simply press the replaceable floor mat cover(s) 101 in place during installation and pull (or roll) the sheet away at the time of removal. The mat base 104 may comprise a rubber-like material or a plastic material.

Other versions of the invention may include an optional set of pull tabs 105 placed at the top (and at one end of the mat base 104) of the replaceable floor mat covers 101 to aid in the removal of the replaceable fabric/paper. This technique may also allow for ease of use without having to remove the floor mat 100 from the vehicle. Actual tab locations and quantities may be determined based on the size and shape of the particular floor mat 100, and vehicle model floor design limitations.

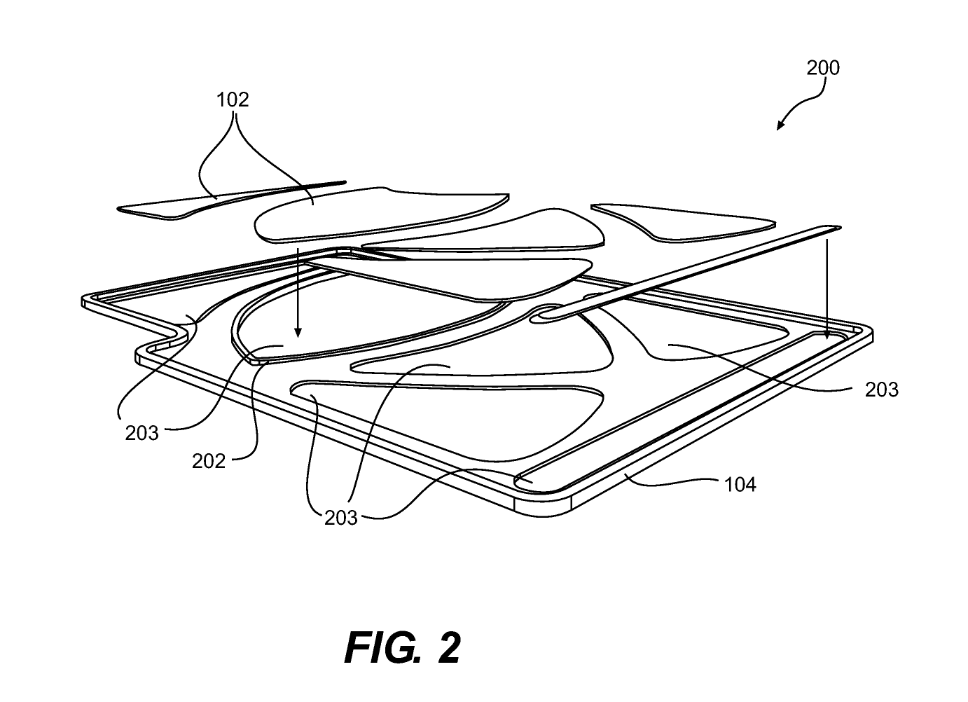

FIG. 2 illustrates an exemplary floor mat, showing the mat base and hook and loop pieces, configured according to principles of the invention, generally denoted by reference 200. The floor mat base 104 may have a raised area 202 configured to allow for alignment of the replaceable floor mat covers 101 (FIG. 1), and may include recessed areas 203 which may allow for the placement of the hook pieces 103 and loop pieces 102 (such as Velcro®, a trademark of Velcro Industries, B.V.), according to principles of the invention. Alternate versions of the floor mat may include the use of snaps or magnets, such as neodymium magnets, for example, recessed into the floor mat base 104 and partially built-in to the bottom of the replaceable floor mat covers 101, and set deep enough to accommodate the mating of the hooks and loops to further allow the replaceable floor mat covers 101 to rest flat on the floor mat base 104. A floor mat 200 with these raised areas 202 may help keep the replaceable sheets from moving in a lateral direction.

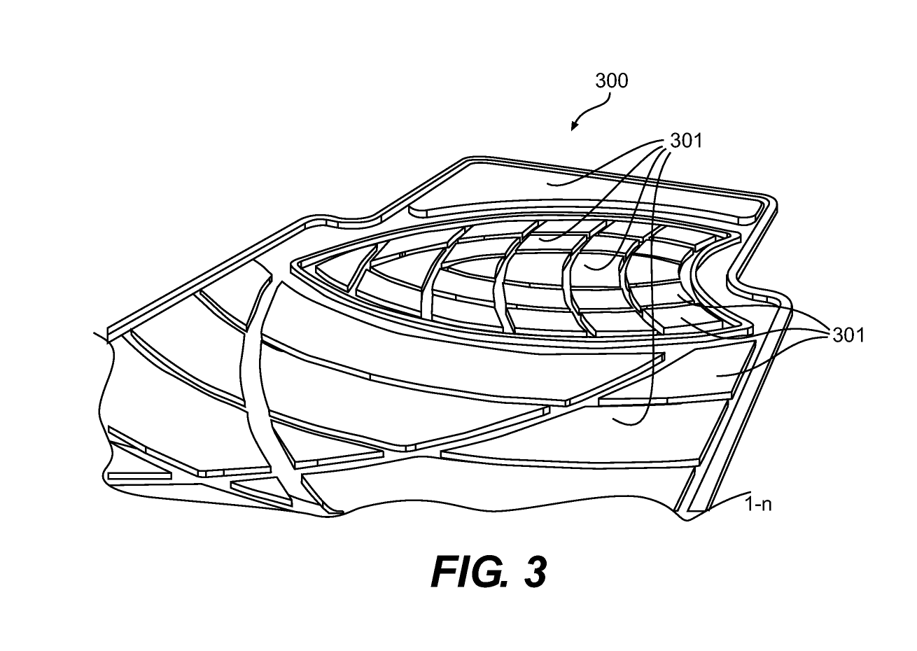

FIG. 3 is a perspective view of an exemplary illustration of a floor mat configured according to principles of the invention, generally denoted by reference 300. The floor mat 300 shows various pocket formations 301 designed to contain absorbing material. The pocket formations 301 may be formed in a paper. Pocket formations 301 may be configured to fit into an adjacent pocket formation(s) of another cover, thereby forming layers of removable covers 101, the set of removable covers denoted by (1-n) in FIG. 3. Moreover, the raised areas may provide added footwear traction. One version of the replaceable floor mat cover 101 may include pocket formations 301 that may include a superabsorbent polymer or fabric/paper which may expand to soak-up water, according to principles of the invention. It may be preferable (but not a requirement) that the replaceable floor mat cover 101 may be made from recycled material (i.e., paper, plastic, etc.) to reduce cost and may also be dye-able to give the consumer several choices of color, One example of a replaceable floor mat cover 101 may be a fiberglass fabric or fiberglass reinforced fabric, which may also work in conjunction with other absorbent materials such as superabsorbent polymers, chamois leather, foam, etc., thus allowing the replaceable floor mat cover 101 to withstand foot traffic abuse without excessive degrading (i.e., tearing, shredding, ripping, etc.). The type of replaceable floor mat cover 101 should extend to be usable in various weather and terrain conditions, and also for use with various types of footwear, as well, so as to not tear a hole in the floor mat paper (e.g., a consumer scuffing their foot across the mat when entering or exiting the vehicle). The replaceable floor mat cover(s) 101 may also be optionally treated with a water repellant and/or stain resistant substance like Scotchguard™, for example, to protect it from stains in order to preserve the new look of the floor mat cover. A further example of an exemplary superabsorbent polymer may be hydrogel which is sometimes found in certain baby diapers, for example. These polymers may absorb water through hydrogen bonding and might swell to 500 times their weight. Other examples of the invention may also include a thicker replaceable paper which may provide a higher level of absorbency, a sponge material used within the paper to absorb water, or a durable fabric over foam (i.e., carpet type padding foam, foam sponge, etc), or, in the alternative, the replaceable floor mat cover 101 may be substituted by a water absorbing fiber (e.g., hydrofiber), or a reusable silica gel may be employed in the replacement floor mat either in the base or in the covers 101 that can be reactivated indefinitely. Furthermore, the replaceable floor mat cover 101 is constructed to maintain strength and durability when wet, due to rain or melting snow.

In one aspect, the replaceable floor mat cover 101 may be constructed to be resistant to water so that the floor mat simply resists or contains the water, but does not substantially absorb water. One advantage of this approach is that the water may not soak into the second, third, or other layers (in the instance of a multi-layer replaceable cover pack) causing water stains, which would keep the underneath layers presentable at the time of use. This may be achieved by using a plastic liner (not shown), or alternatively, a water resistant spray-on barrier on the bottom of each sheet. A second advantage to this technique is to keep the floor mat dry to eliminate worries about water accidentally spilling onto the interior of the vehicle (e.g., the vehicle carpet) when going around a corner or driving down a rough road. Any one of the above examples of proposed replaceable floor mat cover 101 may also contain one or more of an anti-bacterial, anti-fungal or anti-microbial chemical such as those used in premium hypoallergenic carpet pads, thereby promoting a healthier environment, such as the odor absorbing chemicals used in Arm & Hammer® baking soda, or the water resistant spray-on barrier analogous to that used in StainMaster® carpet cushion, for example. Finally, the picket formations 301 on the replaceable floor mat cover 101 may be raised to offer foot traction, configured according to principles of the invention.

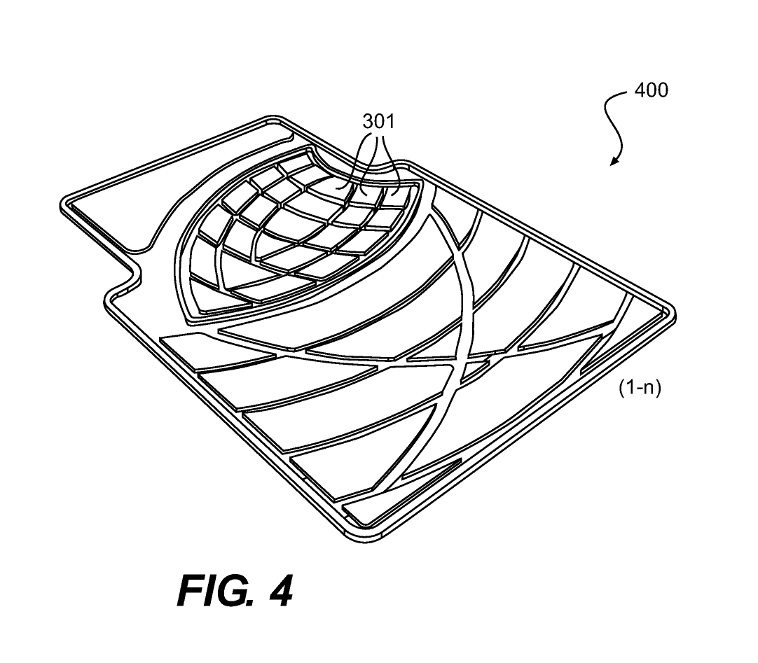

FIG. 4 is a perspective view of a fully assembled exemplary floor mat configured according to principles of the invention, generally denoted by reference 400. This perspective shows alternate topographical designs. FIG. 4 further illustrates a specific design pattern which may help to maintain foot traction and to clean various forms of footwear. Other designs may be employed. The floor mat 400 may comprise a plurality of removable layers of replaceable floor mat covers (e.g., layers 101 of FIG. 1), the plurality of removable layers being denoted by notation (1-n) in FIG. 4.

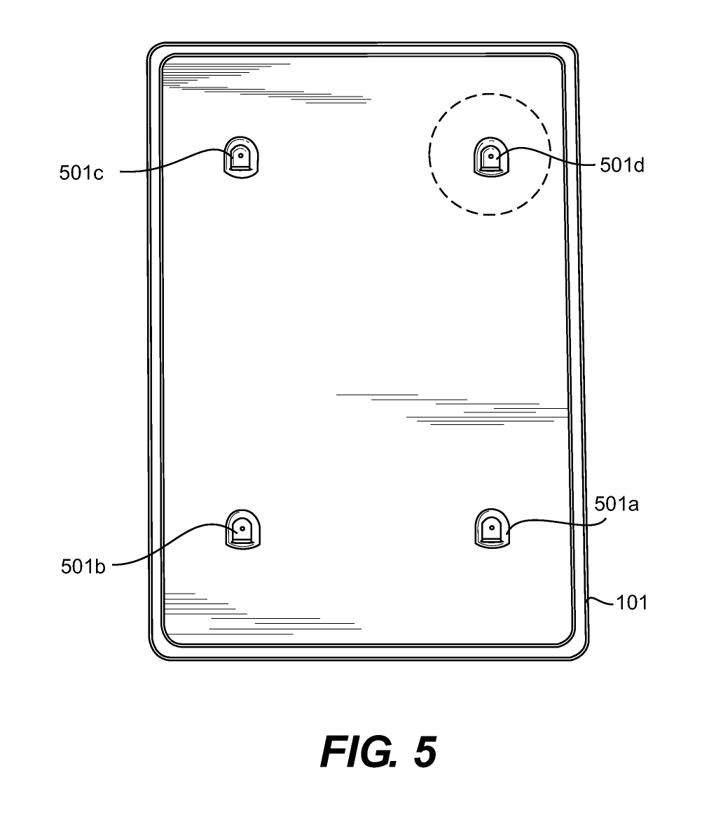

FIG. 5 is an illustration showing a set of push-up tabs, attached to the base of the floor mat to be used to hold replaceable floor mat covers in place, configured according to principles of the invention. The push-up tabs 501a, 501b, 501c and 501d, may swivel 90 degrees over the replaceable floor mat covers 101. Actual swivel latch locations and quantities may be determined based on the size and shape of the particular floor mat 100.

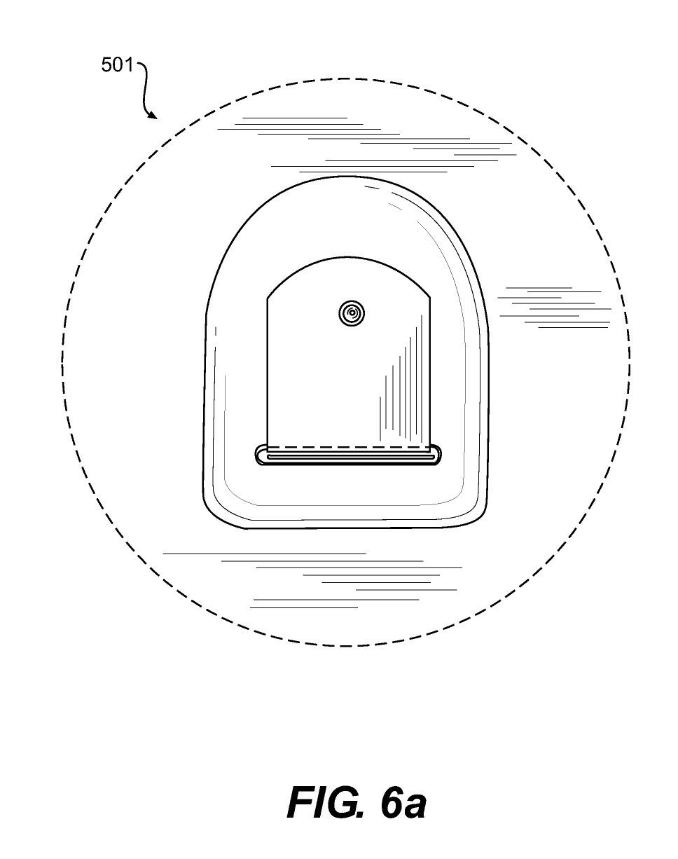

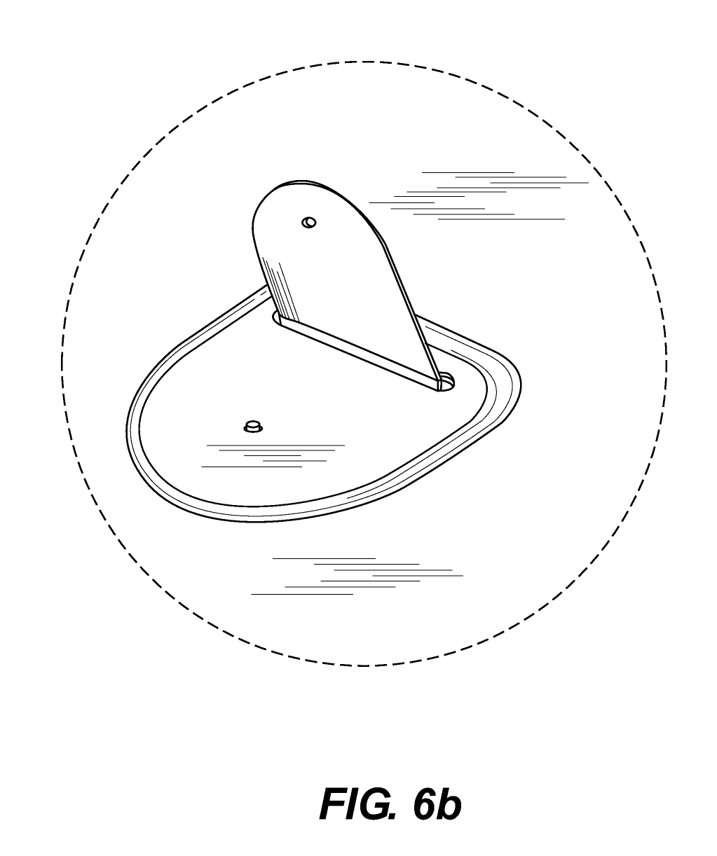

FIG. 6a is a close up and top view of the push-up tab of FIG. 5, according to principles of the invention. The push-up tab 501 may be used to hold the mat in place.

FIG. 6b is a perspective view of the push-up tab of FIG. 5, configured according to principles of the invention.

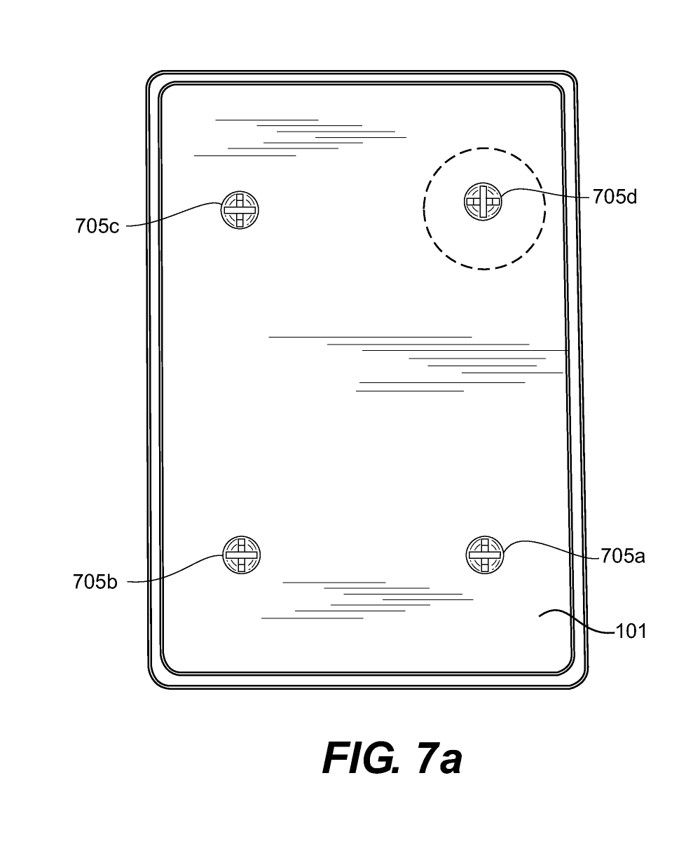

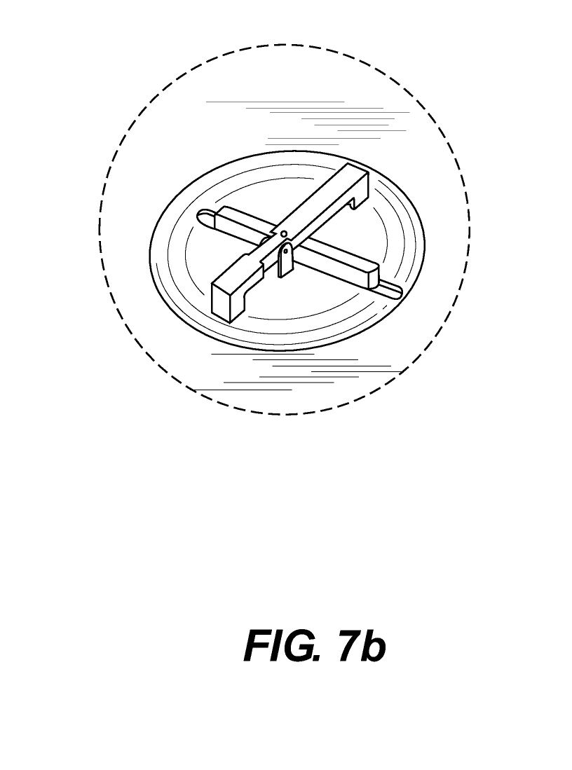

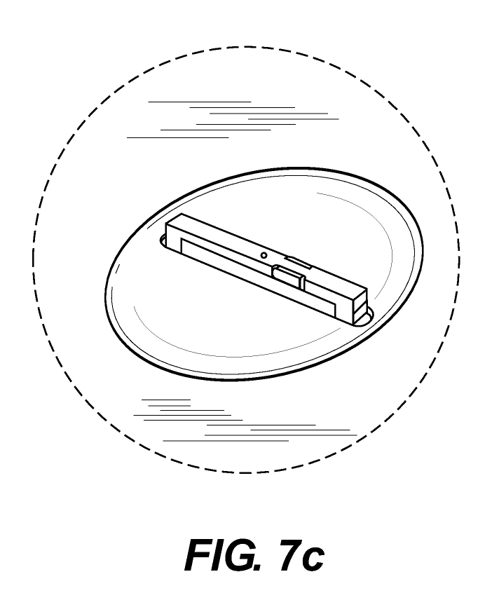

FIG. 7a is an illustration of tabs, configured according to principles of the invention. The push-up tab 705a-d may be used to demonstrate an alternate interlocking method to hold the replaceable floor mat covers 101 in place, configured according to principles of the invention.

FIG. 7b is a perspective view of a swivel tab of FIG. 7a, in a locked position, configured according to principles of the invention. The swivel tab may be used to show a closer perspective of the tab in its interlocked state.

FIG. 7c is an additional perspective view of the exemplary swivel tab of FIG. 7a, in an unlocked position, configured according to principles of the invention. The swivel tab is shown in an unlocked mode.

The floor mat constructed according to principles herein may include one or more replaceable covers that permit removal by a user. The one or more replaceable covers may be a plurality of covers configured to be removed one at a time when a top most cover has become soiled/stained. The floor mat may be configured to generally match the floor space of a vehicle for which it is to guard the inside floor surface from dirt, wetness and the like.

The floor mat may be configured with retaining mechanisms to hold the floor covers to the floor mat. The cover(s) may comprise paper-like sheet(s) or polymer-like sheet(s) that may be constructed to absorb wetness and/or dirt. In some aspects, the cover(s) may be constructed to resist staining, while also permitting absorption of wetness. In some embodiments, the cover(s) may be constructed with recesses or raised areas to permit water absorbing materials to be held in place for absorbing moisture. The absorbing materials may comprise gels, solids or other desiccant-like compounds. Alternatively, the absorbing materials can be constructed within a portion of each cover.

While the invention has been described in terms of exemplary embodiments, those skilled in the art will recognize that the invention can be practiced with modifications in the spirit and scope of any claims. These examples given above are merely illustrative and are not meant to be an exhaustive list of all possible designs, embodiments, applications or modifications of the invention.

I claim:

1. A vehicle floor mat, comprising:
a base configured to hold a set of individually removable covers; and
the set of individually removable covers.

2. The vehicle floor mat of claim 1, wherein the base has at least one recessed area formed by raised portions in the base.

3. The vehicle floor mat of claim 1, further comprising a securing mechanism configured in the base to hold the set of individually removable covers to the base.

4. The vehicle floor mat of claim 3, wherein the securing mechanism comprises one of: a swivel mechanism and a push-up tab mechanism.

5. The vehicle floor mat of claim 1, wherein each of the individually removable covers has a tab for assisting in removing the respective cover.

6. The vehicle floor mat of claim 1, wherein the base has at least one recessed area formed by raised portions in the base to receive an attaching mechanism for attaching the set of individually removable covers to the base.

7. The vehicle floor mat of claim 6, wherein the attaching mechanism comprises a loop mechanism and hook mechanism, wherein one of: the loop mechanism and the hook mechanism being secured to the based within the at least one recessed area for holding the set of individually removable covers to the base.

8. The vehicle floor mat of claim 1, wherein the set of individually removable covers comprises a material including at least one of: a paper, a polymer and a plastic.

9. The vehicle floor mat of claim 1, wherein the set of individually removable covers are water absorbing.

10. The vehicle floor mat of claim 1, wherein the set of individually removable covers are water resistant.

11. The vehicle floor mat of claim 1, further comprising a reusable silica gel removably attached to the base.

12. The vehicle floor mat of claim 1, further comprising a reusable silica gel removably attached to the set of individually removable covers.

13. The vehicle floor mat of claim 1, wherein the set of individually removable covers includes at least one of: an anti-bacterial material, an anti-fungal material and an anti-microbial chemical.

14. The vehicle floor mat of claim 1, wherein the base comprises a rubber-like material or a plastic material.

15. A method for constructing a vehicle floor mat, comprising the steps of:
providing a base configured to hold a set of individually removable covers; and
providing the set of individually removable covers.

16. The method of claim 15, wherein the providing step provides the base having at least one recessed area formed by raised portions in the base.

17. The method of claim 15, further comprising providing a securing mechanism configured in the base to hold the set of individually removable covers to the base.

18. The method of claim 17, wherein the step of providing a securing mechanism provides a securing mechanism comprising one of: a swivel mechanism and a push-up tab mechanism.

19. The method of claim 15, wherein each of the individually removable covers has a tab for assisting in removing the respective cover.

20. The method of claim 15, further comprising providing an attaching mechanism that comprises a loop mechanism and hook mechanism, wherein one of the loop mechanism and the hook mechanism is configured to be secured to the base within at least one recessed area formed in the base for holding the set of individually removable covers to the base

21. The vehicle floor mat of claim 1, wherein the base has at least one recessed area formed by raised portions in the base to receive an attaching mechanism for attaching the set of individually removable covers to the base.

22. The vehicle floor mat of claim 1, where the base and individually removable covers are configured to fit a particular floor pattern for a vehicle.

23. A vehicle floor mat, comprising:
means for providing vehicle floor protection in multiple layers;
means for holding the means for providing vehicle floor protection in multiple layers in place for a specific vehicle floor design,
wherein the multiple layers are individually removable to expose another layer.
